(19) United States
(12) Patent Application Publication
(10) Pub. No.: US 2019/0100108 A1
(43) Pub. Date: Apr. 4, 2019

(54) Robotic Vehicle Renewable Resource Charging Station Management Systems and Methods

(71) Applicant: QUALCOMM Incorporated, San Diego, CA (US)

(72) Inventors: Jonathan Paul DAVIS, Philadelphia, PA (US); Daniel Warren Mellinger, III, Phildelphia, PA (US); Stephen Marc Chaves, Philadelphia, PA (US); Rizwan Ahmed, Haddonfield, NJ (US); Moussa Ben Coulibaly, Brookhaven, PA (US); Yoga Nadaraajan, Pittsbrugh, PA (US); John Anthony Dougherty, Philadelphia, PA (US)

(21) Appl. No.: 15/720,756

(22) Filed: Sep. 29, 2017

(51) Int. Cl. B60L 11/18

(52) U.S. Cl. CPC B60L 11/1824; B60L 11/1816; H02J 7/0027; B60L 2230/22; B60L 2230/24; B60L 2200/10

(57) ABSTRACT

A charging station for a robotic vehicle includes a base configured for use on a body of water; a docking terminal supported on the base, the docking terminal including a charger configured to charge a robotic vehicle docked on the docking terminal; and a renewable energy harvesting device coupled to the charger to provide power to the charger.

### BACKGROUND

Fleets of autonomous unmanned aerial vehicle (UAVs) are useful for a wide array of tasks, such as surveillance, inspection, item delivery, etc. Enabling them to autonomously recharge and fly multiple missions substantially increases the amount of work that a given number of UAVs can do. While many locations on land can have cabled access to the power grid, this becomes more difficult for UAV fleets that would be performing a task over water away from land, such as over a lake or ocean. Flying back to a recharging station on land would require battery power and decrease the flight time a UAV could allocate toward its mission. It is possible to equip UAVs with solar cells to land and recharge autonomously, but given the available surface area on a UAV, generating enough energy may take a very long time, and thus may render the technique less viable.

### SUMMARY

According to various embodiments, a charging station for a robotic vehicle may include (but is not limited to) a base configured for use on a body of water; a docking terminal supported on the base, the docking terminal including a charger configured to charge a robotic vehicle docked on the docking terminal; and a renewable energy harvesting device coupled to the charger to provide power to the charger.

In some embodiments, the renewable energy harvesting device may be configured to harvest solar power for providing power to the charger. In further embodiments, the renewable energy harvesting device may comprise a solar panel array comprising one or more photovoltaic cells. In yet further embodiments, the solar panel array may be configured for movement relative to the base. In yet further embodiments, the solar panel array may be configured for movement relative to the base based on a position of the sun.

In some embodiments, the renewable energy harvesting device may be configured to harvest wind power for providing power to the charger. In further embodiments, the renewable energy harvesting device may comprise one or more wind turbines.

In some embodiments, the renewable energy harvesting device may be configured to harvest water, wave, or tidal power for providing power to the charger.

In some embodiments, the docking terminal may be configured to securely hold the robotic vehicle while the robotic vehicle is charged by the charger.

In some embodiments, the charging station may further include a propulsion device coupled to the base for moving the base. In further embodiments, the propulsion device may comprise one or more propellers.

In some embodiments, the base may be configured to float on the body of water.

In some embodiments, the base may be configured for attachment to a structure supported on a waterbed of the body of water.

In some embodiments, the charging station may further include a battery supported by the base and configured to store energy harvested by the renewable energy harvesting device and to provide the stored energy to provide power to the charger.

In some embodiments, the renewable energy harvesting device may be supported on the base.

In some embodiments, the renewable energy harvesting device may be arranged remote from the base.

In some embodiments, the robotic vehicle may comprise an unmanned aerial vehicle (UAV).

In some embodiments, the robotic vehicle may comprise an aquatic-based vehicle.

In various embodiments, a robotic vehicle charging station may include (but is not limited to) a base configured for use on a body of water; a docking means supported on the base, the docking terminal including a charging means for charging a robotic vehicle docked on the docking terminal; and a renewable energy harvesting means coupled to the charger for providing power to the charger.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic diagram of a UAV docked at a charging station according to various embodiments.

FIG. 2 is a perspective view of a UAV and a schematic relief diagram of a control unit and remote communication device according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a charging station provided on a body of water (e.g., a floating charging station or a charging station provided on a structure supported by a water bed) and equipped with one or more renewable resource harvesting devices (e.g., one or more solar cells) to enabling the charging station to collect and store a significant amount of energy. Accordingly, as UAVs fly out for an over-water mission (e.g., a route that passes at least partially over a body of water), such UAVs could recharge on docking terminal chargers provided on the floating charging station using the energy collected by the renewable energy harvesting devices. The docking terminals (and/or the chargers thereof) may recharge the UAVs through one of a various set of techniques, such as (but not limited to) contact points connected to the battery, physically swapping the battery, wireless power, etc. When recharged, each UAV may fly back out and continue its mission.

The terms “unmanned aerial vehicle” and “UAV” are is used herein to refer to one of various types of aerial vehicles that may not utilize onboard, human pilots. A UAV may include an onboard computing device configured to operate the UAV without remote operating instructions (i.e., autonomously), such as from a human operator or remote computing device. Alternatively, the onboard computing device may be configured to operate the UAV with remote operating instruction or updates to instructions stored in a memory of the onboard computing device. The UAV may be propelled for movement in any of a number of known ways. For example, a plurality of propulsion units, each including one or more propellers or jets, may provide propulsion or lifting forces for the UAV and any payload carried by the UAV for travel or movement. In addition or alternatively, the UAV may include wheels, tank-tread, floatation devices or other non-aerial movement mechanisms to enable movement on the ground or across water. The UAV may be powered by one or more types of power source, such as electrical, chemical, electro-chemical, or other power reserve, which may power the propulsion units, the onboard computing device and/or other onboard components.

As used herein, the term “charging station,” “UAV charging station,” “or robotic vehicle charging station” refers to a location that includes at least one docking terminal with a charger for charging a UAV (e.g., battery thereof). As used herein, the term “docking terminal” refers to a position at the charging station at which the UAV may dock and be charged by the charger. The docking terminal may include (but is not limited to) elements for mechanically coupling, holding, and/or supporting a UAV docked at the docking terminal. In some embodiments, the term “charger” refers to a device for charging an onboard battery of a UAV while the onboard battery remains onboard the UAV (i.e., without removing the battery for charging). The charger at the docking terminal may include (but is not limited to) an electrical receptacle, cord, wireless charger, or mating device for transferring electric charge to a UAV.

As used herein, the terms “dock,” “docked,” or “docking” refer to the act of connecting to and/or parking at a docking terminal of a charging station for more than a brief period. While docked at a docking terminal, a UAV may be charging or may have stopped charging but remains at the docking terminal (i.e., finished charging or ready to leave). While docked, UAVs may mechanically couple to the charger (e.g., a direct connection is formed) or the UAVs may land on or hang from a support structure without a secure connection to the charger (e.g., for wireless charging). Moreover, as used herein, the terms “power” and “energy” may be used interchangeably for charging an onboard battery of a UAV.

The term “computing device” is used herein to refer to an electronic device equipped with at least a processor. Examples of computing devices may include a UAV recharging control, travel control, and/or mission management computers, mobile devices (e.g., cellular telephones, wearable devices, smart-phones, web-pads, tablet computers, Internet enabled cellular telephones, Wi-Fi® enabled electronic devices, personal data assistants (PDA's), laptop computers, etc.), personal computers, and server computing devices. In various embodiments, computing devices may be configured with memory and/or storage as well as networking capabilities, such as network transceiver(s) and antenna(s) configured to establish a wide area network (WAN) connection (e.g., a cellular network connection, etc.) and/or a local area network (LAN) connection (e.g., a wired/wireless connection to the Internet via a Wi-Fi® router, etc.).

The term “server” as used herein refers to any computing device capable of functioning as a server, such as a master exchange server, web server, and a personal or mobile computing device configured with software to execute server functions (e.g., a “light server”). Thus, various computing devices may function as a server, such as any one or all of cellular telephones, smart-phones, web-pads, tablet computers, Internet enabled cellular telephones, WAN enabled electronic devices, laptop computers, personal computers, and similar electronic devices equipped with at least a processor, memory, and configured to communicate with a UAV. A server may be a dedicated computing device or a computing device including a server module (e.g., running an application that may cause the computing device to operate as a server). A server module (or server application) may be a full function server module, or a light or secondary server module (e.g., light or secondary server application). A light server or secondary server may be a slimmed-down version of server type functionality that can be implemented on a personal or mobile computing device, such as a smart phone, thereby enabling it to function as an Internet server (e.g., an enterprise e-mail server) to a limited extent, such as necessary to provide the functionality described herein.

Various embodiments may be implemented using a variety of charging stations and/or charging station configurations. A charging station may have more than one docking terminal with one or more chargers for charging one or more UAVs. In some embodiments, the docking terminal(s) may have a bracket or seating or otherwise be configured to receive and hold a UAV in-place while charging. The docking terminal and/or the charger may be configured with coupling elements configured to mate with elements of the UAV for transferring electrical power, such as to an onboard battery of the UAV.

Various embodiments may be implemented using a variety of UAV configurations. A propulsion source for a UAV may be one or more propellers that generate a lifting or propelling force sufficient to lift and/or move the UAV (including the UAV structure, motors, electronics, and power source) and any loads that may be attached to the UAV (e.g., a payload). The propulsion source may be powered by an electrical power source, such as a battery. While the present disclosure is directed to examples of electric motor controlled UAVs, the claims and embodiments may be applied equally to UAVs powered by various additional types of power source that may be resupplied with a product that may be used or consumable to create energy.

Propulsion sources may be vertical or horizontally mounted depending on the movement mode of the UAV. A common UAV configuration suitable for use in the various embodiments is a “quad copter” configuration. In an example quad copter configuration, four horizontally-configured rotary lift propellers and motors fixed to a frame. However, UAV's may have any number of rotary lift propellers and motors are fixed to the frame. The frame may include a frame structure with landing skids that supports the propulsion motors, power source (e.g., battery), payload securing mechanism, and so on. A payload may be attached in a central area underneath the frame structure platform of the UAV, such as an area enclosed by the frame structure and skids underneath the power sources or propulsion units. A quad copter-style horizontal rotor UAV may travel in any unobstructed horizontal and vertical direction or may hover in one place. A quad copter UAV configuration is used for illustrative purposes in the examples described herein; however, other UAV designs may be used.

A UAV may be configured with processing components that enable the UAV to navigate, such as by controlling the motors to achieve directionality, and communication components that enable the UAV to receive position information and information from external systems including servers, access points, other UAVs, and so on. The position information may be associated with the current UAV position, waypoints, travel paths, avoidance paths/sites, altitudes, destination sites, locations of charging stations, relative locations of other UAVs, potential charging station sites, and/or the like. The position information may be based on a relative position or an absolute position (i.e., geographic coordinates) obtained from a sensor (onboard or remote) or from communications with a computing device (e.g., server, global navigation satellite system (GNSS), or positioning beacon).

The UAV may periodically or continuously monitor onboard available power levels and determine whether the UAV has enough power to reach its destination in accordance with mission power parameters. The mission power parameters may include power requirements for reaching the destination of a course of the UAV. Also, the mission power parameters may include or take into account a threshold level of reserve power allowing a margin of error (e.g., determined from a statistical error analysis). In addition, the mission power parameters may include information about payload encumbrances, route parameters, conditions that impact power consumption (e.g., inclement weather), deadlines (i.e., timing considerations), priority levels, and other information about one or more missions assigned to the UAV.

In case of an emergency or when available onboard power is insufficient to meet one or more mission power parameters, the UAV may assess available information to determine whether the UAV can dock at a docking terminal in a charging station to recharge onboard batteries. For example, when head winds are heavier than expected, the UAV will expend more power than expected to reach its destination, and therefore may need to recharge in order to reach the original destination.

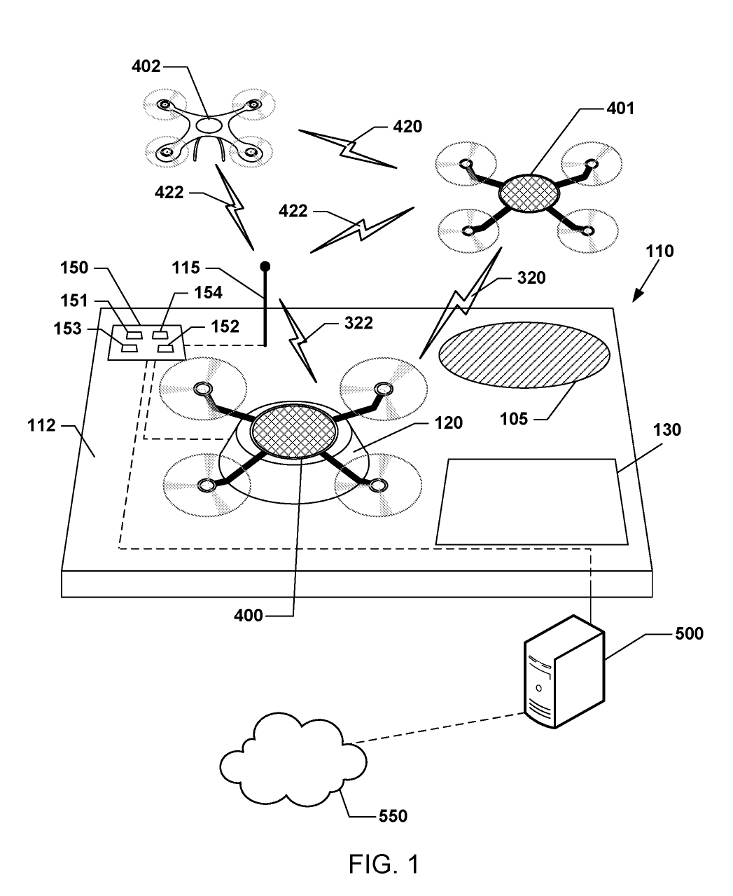

Various embodiments include a charging station 110 including one or more docking terminals 120 with chargers configured to recharge a UAV, such as UAVs 400, 401, 402. Examples of chargers include electrical receptacles, cords, wireless chargers, or mating devices for transferring electric charge to a UAV. The charging station 110 may have more than one docking terminal 120 and each docking terminal 120 may have more than one different type of charger. For example, one charger may be configured to charge special types of UAVs, couple to special types of UAV mating devices, or charge UAVs at a different rate than other chargers. The charging station 110 illustrated in FIG. 1 is in the form of flat open deck platform or base 112; however, other configurations of bases 112 of charging stations may be used.

Multiple UAVs 400, 401, 402 may attempt to dock at the docking terminal 120 to recharge onboard batteries of the UAVs 400, 401, 402, but only one of the UAVs 400, 401, 402 at a time can dock at the docking terminal 120. Alternatively, one of the UAVs 400, 401, 402 that was unable to dock at the docking terminal 120 may be able to land in a waiting zone 105. The waiting zone 105 may be helpful for UAVs too low on power to wait by hovering near the charging station 110 until a docked UAV (e.g., 400) departs. In particular embodiments, the waiting zone 105 does not provide any charging capabilities for recharging a waiting UAV. While in the waiting zone, the waiting UAV may be in a reduced power state relative to when in flight and/or when charging on the docking terminal.

In various embodiments, the charging station 110 includes a control unit 150. The control unit 150 may include a processor 151, one or more transceivers 152 (e.g., Peanut, Bluetooth, Bluetooth LE, ZigBee, Wi-Fi®, radio frequency (RF) radio, etc.), a platform antenna 115, and a power module 153. The processor 151 may include memory 154 and sufficient processing power to conduct various control and computing operations for the charging station 110. The processor 151 may be coupled to and control the docking terminal 120 for charging UAVs docked thereon, such as by being equipped with charging control algorithm and a charge control circuit. The processor 151 may be directly powered from a power source supplying power for charging the UAVs or from the power module 153. The processor 151 may also be coupled to one or more motor or actuation mechanisms for holding or releasing UAVs docked on the docking terminal 120.

The charging station control unit 150 may control and be coupled to sensors (not shown) such as cameras for observing the area surrounding the charging station 110 and monitoring the UAVs 400, 401, 402 approaching for landing.

The processor 151 may communicate with UAVs 400, 401, 402 through the one or more transceivers 152. A bi-directional wireless link 422 may be established between the platform antenna 115 and each of the UAVs 400, 401, 402, such device-to-device (D2D) communications may use Long Term Evolution (LTE) Direct, Wi-Fi direct, or the like. The UAVs 400, 401, 402 may also use inter-UAV wireless links 420 for directly communicating to one another. The inter-UAV wireless links 420 may also use D2D communication protocols. The charging station 110 may also include network access ports (or interfaces) coupled to the processor 151 for establishing data connections with a network, such as the Internet 550 and/or a local area network coupled to other systems computers and a server 500.

In particular embodiments, the charging station 110 may be configured for WAN communication (e.g., via the transceiver(s) 152 to exchange data between a charging or nearby UAV 400, 401, 402 and the Internet 500 and/or a remote server (e.g., 550). For instance, the charging or nearby UAV 400 may transfer data to the charging station 110 using a first wireless communication protocol, such as a WLAN (e.g., Wi-Fi) or PAN protocol, to allow the charging station 110 to send the received data to the remote server 500 using a second wireless communication protocol, such as a WWAN protocol. The charging station 110 may send the received data to the remote server 500 while the UAV 400 charges or even after the UAV 400 departs (e.g., after charging). Likewise, the charging station 110 may receive data from the remote server 500 and send the received data to the charging or nearby UAV 400.

Charging stations (e.g., 110) may be located on building rooftops, which are isolated locations that may provide security. However, high altitudes often experience severe wind conditions that may damage or destroy a UAV. While the charging station 110 is illustrated as a flat open deck, numerous other configurations may be suitable for charging the UAVs in accordance with various embodiments. In various embodiments, the charging station 110 may deploy a grappling component or stabilizer to secure the UAV 400 to the charging station 110.

Different types of locations may be suitable for a charging station 110, such as (but not limited to) commercial buildings, power or communication towers, and/or the like. Charging stations are not limited to being located on building rooftops or even man-made objects. For example, natural locations like cliffs, hilltops, rocks, open fields, or on a flotation device on a lake, pond, river, or other body of water, and/or the like may be suitable as a charging station 110. In particular embodiments, the charging station 110 (e.g., the base 112) is configured to float on a body of water to allow UAVs 400, 401, 402 to dock and/or charge thereon. In other embodiments, the charging station 110 may be tethered to an object such as a buoy, anchor, boat, the water bed, etc. In other embodiments, the charging station 110 (e.g., the base 112) may be arranged on a support structure on a body of water. For instance, the support structure (on which the charging station 110 is supported) may be anchored to the water bed.

In some embodiments, the charging station 110 may include a renewable resource harvesting device configured to harvest renewable energy from sources such as (but not limited to) solar, wind, wave, tidal, water (e.g., for harvesting falling water or fast-running water), and/or the like. In particular embodiments, the renewable resource harvesting device may be a solar panel array (comprising one or more photovoltaic cells). In some embodiments, the renewable resource harvesting device may be one or wind turbines or other wind-harvesting devices. In some embodiments, the renewable resource harvesting device may be configured to harvest energy from motion of the renewable resource harvesting device (and/or the charging station 110) caused by waves, current, rivers, etc. In some embodiments, multiple renewable resource harvesting devices, for example each harvesting a different type of energy, may be provided. For example, the charging station 110 could include a solar panel array as well as include a tidal power harvesting device.

Energy collected (and/or converted by the charging station 110) may be stored in on-board batteries (not shown) and/or may directly power a charging UAV 400.

In various embodiments, the docking terminal 130 (and/or other components) of the charging station 110 may be configured to securely hold the UAV 400 while charging. For instance, the docking terminal 130 may be configured to magnetically couple, clamp, or otherwise secure the UAV 400 to the docking terminal 130. Such embodiments may mitigate the possibility that a wave or a strong gust of wind knocks off the charging UAV.

In some embodiments, the charging station 110 may be configured for controlled movement (e.g., by a remote party, autonomously, etc.). For instance, the charging station 110 may include a propulsion device for movement, such as (but not limited to), a propeller, a sail, or the like. In embodiments in which the charging station 110 includes one or more propellers, the one or more propellers may be driven by an on-board internal combustion engine (not shown). Alternatively or in addition, one or more of the propellers may be driven by a motor powered by a battery, which may be powered by energy collected by the renewable energy harvesting device 130). Thus, the charging station 110 may be moved to a more suitable area, for example, an area with better renewable energy harvesting conditions (e.g., more sun, wind, waves, etc.), a location to meet a UAV 400 (e.g., a UAV with too low of a charge to navigate to the charging station 110), to specified area (e.g., an area known to have many UAVs, a point of origin or home, etc.), to avoid the current area (e.g., to avoid an incoming storm, clouds, or the like).

In some embodiments, the renewable resource harvesting device may be remote from the charging station 110. In such embodiments, the renewable resource harvesting device may be coupled to (e.g., via a wired or wireless power transmission line) the charging station 110 to provide power to the charging station 110 to power the charging station 110 and/or UAVs docked or charging thereon. In some embodiments, the charging station 110 may be configured to receive additional power from a traditional power grid to supplemental charging of the UAVs 400. For instance, the charging station 110 may be coupled (e.g., via a wired or wireless power transmission line) to the power grid.

In some embodiments, multiple charging stations 110 may be interconnected in any suitable arrangement (e.g., daisy chain, wheel and spoke, etc.). In particular embodiments, one or more renewable energy harvesting devices 130 from various charging stations 110 may be used to charge a single UAV (e.g., 400) for recharging of the UAV.

In various embodiments, the charging station 110 is generally described as for charging aerial robotic vehicles (e.g., UAVs). However, in other embodiments, the charging station 110 may be configured to charging other types of robotic vehicles, such as aquatic-based robotic vehicles. For instance in some embodiments, the charging station 110 may be configured with a ramp or other configuration that allows an aquatic-based robotic vehicle to drive up onto the charging station 110 and be charged by the docking terminal 130. In other embodiments, one or more docking terminals 130 may be arranged on a bottom side of the charging station 110, for instance, on the water-facing surface of the charging station 110. In such embodiments, aquatic-based robotic vehicles may approach the bottom side of the charging station 110 and dock with one of the docking terminals 130 for charging. The docking terminals 130 and/or the charging station 110 may be configured to securely hold the aquatic-based robotic vehicle while it charges.

In some embodiments in which the renewable energy harvesting device 130 includes a solar panel array, the solar panel array may be arranged or otherwise configured to maximize solar collection. For instance, solar collection may be maximized when the light from the sun is perpendicular to the solar panel array. Thus, in particular embodiments, the solar panel (or photovoltaic cells thereof) may be configured to move in relation to the position of the sun in the sky to maximize solar collection (e.g., by being perpendicular to the light from the sun). The position of the sun may be determined in any suitable manner, such as (but not limited to) using a sensor or accessing a database for the expected position of the sun for the location of the charging station 110. In alternative or further embodiments, the charging station 110 may be configured to move or otherwise position/orient itself to maximize solar collection.

In some embodiments, the charging station 110 may be configured to minimize water, salt, or other unwanted material (e.g., dust, pollen, ash, bird feces, etc.) collecting on the solar panel array, which would otherwise affect how much energy is collected by the solar panel array. For instance, the solar panel array (or photovoltaic cells thereof) may be configured to articulate and/or be arranged at a non-zero angle to allow water or the like landing on the solar panel array to run off. As another example, the charging station 110 may include a wiper mechanism to wipe down or off (e.g., periodically or in response to some trigger) the solar panel array to remove any such unwanted material that could affect solar collection.

In some embodiments, the charging station 110 may include a shield (e.g., a retractable shield) or the like to protect a charging UAV or other components of the charging station 110. In particular embodiments, the solar panel array (or at least some photovoltaic cells) may be arranged on the exterior of the shield.

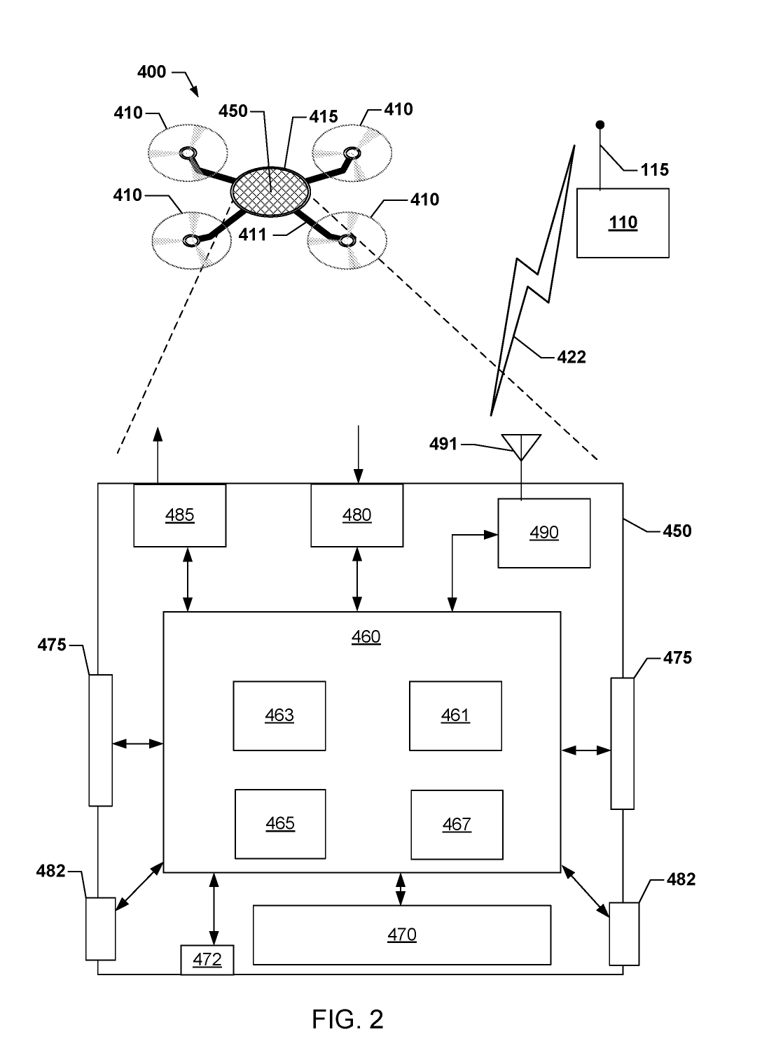

FIG. 2 illustrates a UAV, such as the UAV 400 (or 401, 402) of FIG. 1, in accordance with various embodiments. With reference to FIGS. 1-2, the UAV 400 may include a number of rotors 410, rotor arms 411, and a frame 415. The frame 415 may provide structural support for the motors associated with the rotors 410, landing gear, and a control unit 450. The frame 415 may be sufficiently strong to support the maximum load weight for the combination of the components of the UAV 400 and, in some cases, a payload. For ease of description and illustration, some detailed aspects of the UAV 400 are omitted such as wiring, frame structure, interconnects, or other features that would be known to one of skill in the art. For example, while the UAV 400 is shown and described as having a frame 415 having a number of support members or frame structures, the UAV 400 may be constructed using a molded frame in which support is obtained through the molded structure. In the illustrated embodiments, the UAV 400 has four rotors 410. However, more or fewer than four rotors 410 may be used.

The UAV 400 may further include a control unit 450 (e.g., 150 in FIG. 1) that may house various circuits and devices used to power and control the operation of the UAV 400. The control unit 450 may include a processor 460 (e.g., 151 in FIG. 1), a power module 470, a charging interface 472, payload-securing units 475, an input module 480, sensors 482, an output module 485, and a radio module 490. The processor 460 may include or be coupled to memory 461 and a navigation unit 463. The processor 460 may be configured with processor-executable instructions to control travel and other operations of the UAV 400, including operations of the various embodiments. The processor 460 may be coupled to one or more payload-securing units 475 and sensors 482. The payload-securing units 475 may include an actuator motor that drives a gripping and release mechanism and related controls that are responsive to the control unit 450 to grip and release a payload in response to commands from the control unit 450.

The sensors 482 may be optical sensors, radio sensors, a camera, or other sensors. Alternatively or additionally, the sensors 482 may be contact or pressure sensors that may provide a signal that indicates when the UAV 400 has made contact with a surface. The power module 470 may include one or more batteries that may provide power to various components, including the processor 460, the payload-securing units 475, the input module 480, the sensors 482, the output module 485, and the radio module 490. In addition, the power module 470 may include energy storage components, such as rechargeable batteries. An external power source, such as a charger from a charging station (e.g., 110 in FIG. 1) may supply power to the UAV 400 through the charging interface 472. The charging interface 472 may have mechanical contacts for receiving electricity through conduction. Alternatively, or additionally, the charging interface 472 may be configured to receive power through wireless charging. The processor 460 may be configured with processor-executable instructions to control the charging of the power module 470 (i.e., the storage of harvested energy), such as by executing a charging control algorithm using a charge control circuit. Alternatively or additionally, the power module 470 may be configured to manage its own charging. The processor 460 may be coupled to an output module 485, which may output control signals for managing the motors that drive the rotors 410 and other components, such as a grappling component (not shown).

Through control of the individual motors of the rotors 410, the UAV 400 may be controlled as the UAV 400 progresses toward a destination. The processor 460 may receive data from the navigation unit 463 and use such data in order to determine the present position and orientation of the UAV 400, as well as the appropriate course towards the destination or intermediate sites. In various embodiments, the navigation unit 463 may include a GNSS receiver system (e.g., one or more global positioning system (GPS) receivers) enabling the UAV 400 to navigate using GNSS signals. Alternatively or in addition, the navigation unit 463 may be equipped with radio navigation receivers for receiving navigation beacons or other signals from radio nodes, such as navigation beacons (e.g., very high frequency (VHF) omni-directional range (VOR) beacons), Wi-Fi® access points, cellular network sites, radio station, remote computing devices, other UAVs, etc.

The processor 460 and/or the navigation unit 463 may be configured to communicate with a server through a wireless connection (e.g., a cellular data network) to receive data useful in navigation, provide real-time position reports, and assess data. An avionics module 467 coupled to the processor 460 and/or the navigation unit 463 may be configured to provide travel control-related information such as altitude, attitude, airspeed, heading and similar information that the navigation unit 463 may use for navigation purposes, such as dead reckoning between GNSS position updates. The avionics module 467 may include or receive data from a gyro/accelerometer unit 465 that provides data regarding the orientation and accelerations of the UAV 400 that may be used in navigation and positioning calculations.

The processor 460 may use the radio module 490 to conduct wireless communications with a variety of wireless communication devices, such as a beacon, server, smartphone, tablet, or other computing device with which the UAV 400 may be in communication. Wireless communications (e.g., using a bi-directional wireless link 422) may be established between a UAV antenna 491 of the radio module 490 and platform antenna 115 of the charging station 110. The radio module 490 may be configured to support multiple connections with different wireless communication devices. The UAV 400 may communicate with a server through one or more intermediate communication links, such as one or more network nodes or other communication devices.

In various embodiments, the radio module 490 may be configured to switch between a cellular connection and a Wi-Fi® or other form of radio connection depending on the location and altitude of the UAV 400. For example, while in flight at an altitude designated for UAV traffic, the radio module 490 may communicate with a cellular infrastructure in order to maintain communications with a server. An example of a flight altitude for the UAV 400 may be at around 400 feet or less, such as may be designated by a government authority (e.g., FAA) for UAV flight traffic. At this altitude, it may be difficult to establish communication with some of the wireless communication devices using short-range radio communication links (e.g., Wi-Fi®). Therefore, communications with other wireless communication devices may be established using cellular telephone networks while the UAV 400 is at flight altitude. Communication between the radio module 490 and the charging station 110 may transition to a short-range communication link (e.g., Wi-Fi® or Bluetooth®) when the UAV 400 moves closer to the charging station 110. Similarly, the UAV 400 may include and employ other forms of radio communication, such as mesh connections with other UAVs or connections to other information sources (e.g., balloons or other stations for collecting and/or distributing weather or other data harvesting information).

In various embodiments, the control unit 450 may be equipped with the input module 480, which may be used for a variety of applications. For example, the input module 480 may receive images or data from an onboard camera or sensor, or may receive electronic signals from other components (e.g., a payload). The input module 480 may receive an activation signal for causing actuators on the UAV to deploy clamps (e.g., grappling component) or similar components for securing itself. In addition, the output module 485 may be used to activate components (e.g., an energy cell, an actuator, an indicator, a circuit element, a sensor, a grappling component, adjustment of landing columns, and/or an energy-harvesting element).

While the various components of the control unit 450 are illustrated as separate components, some or all of the components (e.g., the processor 460, the output module 485, the radio module 490, and other units) may be integrated together in a single device or module, such as a system-on-chip module.

When selecting from multiple available charging stations and/or docking terminals, the processor 460 of the UAV 400 may select a preferred charging station and/or docking terminal based on various factors, such as (but not limited to) which one best meets the current mission power parameters of the UAV 400 based on its location. The UAV 400 may take many considerations into account, such as (but not limited to) a speed at which the docking terminal charges, how long the docking terminal may be available, safety, cost, and/or the like, before selecting a particular charging station and/or a particular docking terminal at a charging station.

The UAV 400 may access charging station data from an onboard source (e.g., memory 461, sensors 482, or input module 480) or a remote source (e.g., server 500 or other source on from the Internet 550). In addition, charging station data may originate or come directly from other UAVs 401, 402. For example, the server 500 may provide general information about the coordinates of the charging station 110 or other information such as time-of-day, and weather-related information. Further, while charging batteries at the charging station 110, the UAV 400 may receive a charging station data updates (e.g., changes of availability of one or more other charging stations) or other information such as notice of an approaching storm or other events.

Some charging station sites may have time-of-day restrictions, require certain authorizations, or have other access limitations. Risks, for example, at a site may reflect a likelihood that people or creatures might interfere or tamper with the UAV 400, how stable or reliable the positions at a site may be for a UAV 400, etc.

In some embodiments, the information stored in the memory of the UAV 400 may have a limited useful life, which may be indicated when the information is obtained (e.g., by an expiration time). The UAV 400 may track the expiration of the information stored in the memory using a timer or the like. For example, if the database information has expired or is otherwise beyond the indicated useful life, the UAV processor may contact the server to reload the latest database information. In some embodiments, a UAV storing expired database information may not be allowed to deviate from a current course, except in an emergency.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A charging station for a robotic vehicle comprising:
a base configured for use on a body of water;
a docking terminal supported on the base, the docking terminal including a charger configured to charge a robotic vehicle docked on the docking terminal; and
a renewable energy harvesting device coupled to the charger to provide power to the charger.

2. The charging station of claim 1, wherein the renewable energy harvesting device is configured to harvest solar power for providing power to the charger.

3. The charging station of claim 2, wherein the renewable energy harvesting device comprises a solar panel array comprising one or more photovoltaic cells.

4. The charging station of claim 3, wherein the solar panel array is configured for movement relative to the base.

5. The charging station of claim 3, wherein the solar panel array is configured for movement relative to the base based on a position of the sun.

6. The charging station of claim 1, wherein the renewable energy harvesting device is configured to harvest wind power for providing power to the charger.

7. The charging station of claim 6, wherein the renewable energy harvesting device comprises one or more wind turbines.

8. The charging station of claim 1, wherein the renewable energy harvesting device is configured to harvest water, wave, or tidal power for providing power to the charger.

9. The charging station of claim 1, wherein the docking terminal is configured to securely hold the robotic vehicle while the robotic vehicle is charged by the charger.

10. The charging station of claim 1, further comprising:
a propulsion device coupled to the base for moving the base.

11. The charging station of claim 10, wherein the propulsion device comprises one or more propellers.

12. The charging station of claim 1, wherein the base is configured to float on the body of water.

13. The charging station of claim 1, wherein the base is configured for attachment to a structure supported on a waterbed of the body of water.

14. The charging station of claim 1, further comprising:
a battery supported by the base and configured to store energy harvested by the renewable energy harvesting device and to provide the stored energy to provide power to the charger.

15. The charging station of claim 1, wherein the renewable energy harvesting device is supported on the base.

16. The charging station of claim 1, wherein the renewable energy harvesting device is arranged remote from the base.

17. The charging station of claim 1, wherein the robotic vehicle comprises an unmanned aerial vehicle (UAV).

18. The charging station of claim 1, wherein the robotic vehicle comprises an aquatic-based vehicle.

19. A robotic vehicle charging station comprising:
a base configured for use on a body of water;
a docking means supported on the base, the docking terminal including a charging means for charging a robotic vehicle docked on the docking terminal; and
a renewable energy harvesting means coupled to the charger for providing power to the charger.
